(19) United States
(12) Patent Application Publication
(10) Pub. No.: US 2014/0156169 A1
(43) Pub. Date: Jun. 5, 2014

(54) CONTROL SYSTEM FOR MULTI-CYLINDER ENGINE

(71) Applicants: Aaron Foege, Westmont, IL (US); David Todd Montgomery, Edelstein, IL (US); Farhan Devani, Morton Grove, IL (US); Scott B. Fiveland, Metamora, IL (US)

(72) Inventors: Aaron Foege, Westmont, IL (US); David Todd Montgomery, Edelstein, IL (US); Farhan Devani, Morton Grove, IL (US); Scott B. Fiveland, Metamora, IL (US)

(73) Assignee: Electro-Motive Diesel Inc., LaGrange, IL (US)

(21) Appl. No.: 13/692,651

(22) Filed: Dec. 3, 2012

(51) Int. Cl. F02D 41/30

(52) U.S. Cl. CPC F02D 41/30
USPC 701/103

(57) ABSTRACT

A control system for fuel delivery systems associated with cylinders of a multi-cylinder engine is provided. The control system includes a detector, a processor, and an actuator. The detector is configured to sense a signal to change from a compression ignited fuel to a spark ignited fuel in a pre-determined number of cylinders. The processor is configured to receive the signal from the detector and generate one or more actuation signals. The controller is configured to receive the actuation signals and tandemly control the fuel delivery systems associated with the pre-determined cylinders based on the actuation signals.

### TECHNICAL FIELD

The present disclosure relates to a control system for a multi-cylinder engine, and more particularly to a control system for fuel delivery systems associated with cylinders of the multi-cylinder engine.

### BACKGROUND

Conventional fuel changeover systems for engines may allow a change in fuel type input to the engine. However, in specific cases, when transitioning from a compression ignited fuel, such as diesel, to a spark ignited fuel, such as gasoline or natural gas, residual by-products resulting from the combustion of the compression ignited fuel may be left behind in a cylinder of the engine. Typically, pre-ignition characteristics of spark ignited fuels may be different from that of compression ignited fuels. The residual by-products left behind in the cylinder of the engine may cause detrimental effects such as knocking, or detonation from pre-ignition of the spark ignited fuel. Thus, the residual by-products may negatively impact transitioning from the compression ignited fuels to the spark ignited fuels within the engine and deteriorate engine performance.

PCT Application 2011/098077 relates to a method for switching the fuel supply to an internal combustion engine from a first fuel to a second fuel. The method comprises the steps of operating the internal combustion engine using the first fuel, lowering the fraction of the first fuel in the fuel line supplying first fuel to the internal combustion engine and increasing the fraction of the second fuel in the fuel line supplying second fuel to the internal combustion engine, operating the internal combustion engine using a fuel mixture comprising the first fuel and the second fuel, and repeating the preceding steps until the internal combustion engine is operated only using the second fuel.

### SUMMARY

In one aspect, the present disclosure provides a control system for fuel delivery systems associated with cylinders of a multi-cylinder engine. The control system includes a detector, a processor, and an actuator. The detector is configured to sense a signal to change from a compression ignited fuel to a spark ignited fuel in a pre-determined number of cylinders. The processor is configured to receive the signal from the detector and generate one or more actuation signals. The controller is configured to receive the actuation signals and tandemly control the fuel delivery systems associated with the pre-determined cylinders based on the actuation signals.

In another aspect, the present disclosure provides a power system including the multi-cylinder engine, multiple fuel delivery systems, and the control system. The fuel delivery systems are associated with the cylinders of the multi-cylinder engine and configured to deliver at least one of a compression ignited fuel and a spark ignited fuel. The control system is operatively connected to the fuel delivery systems and includes the detector, the processor, and the controller. The detector is configured to sense a signal to change from the compression ignited fuel to the spark ignited fuel in a pre-determined number of cylinders. The processor is configured to receive the signal from the detector and generate one or more actuation signals. The controller is configured to receive the actuation signals and tandemly control the fuel delivery systems associated with the pre-determined cylinders based on the actuation signals.

In another aspect, the present disclosure provides a method of changing a fuel type in a multi-cylinder engine. The method includes allowing delivery of a compression ignited fuel into cylinders of the engine. The method further includes pre-determining a number of cylinders. The method further includes sensing a signal to change from the compression ignited fuel to the spark ignited fuel in the pre-determined cylinders. The method further includes processing the signal to generate one or more actuation signals. The method further includes tandemly controlling the fuel delivery systems associated with the pre-determined cylinders based on the actuation signals.

Other features and aspects of this disclosure will be apparent from the following description and the accompanying drawings.

### BRIEF DESCRIPTION OF THE DRAWINGS

FIG. 1 is a schematic of a power system in accordance with an embodiment of the present disclosure;

FIGS. 2-5 are sectional views of an engine of the power system when the engine is operating on a compression ignited fuel;

FIGS. 6-13 are sectional views of the engine operating on the compression ignited fuel and a spark ignited fuel;

FIGS. 14-17 are sectional views of the engine executing one or more motoring cycles; and

FIG. 18 shows a method of changing a fuel type in the engine.

### DETAILED DESCRIPTION

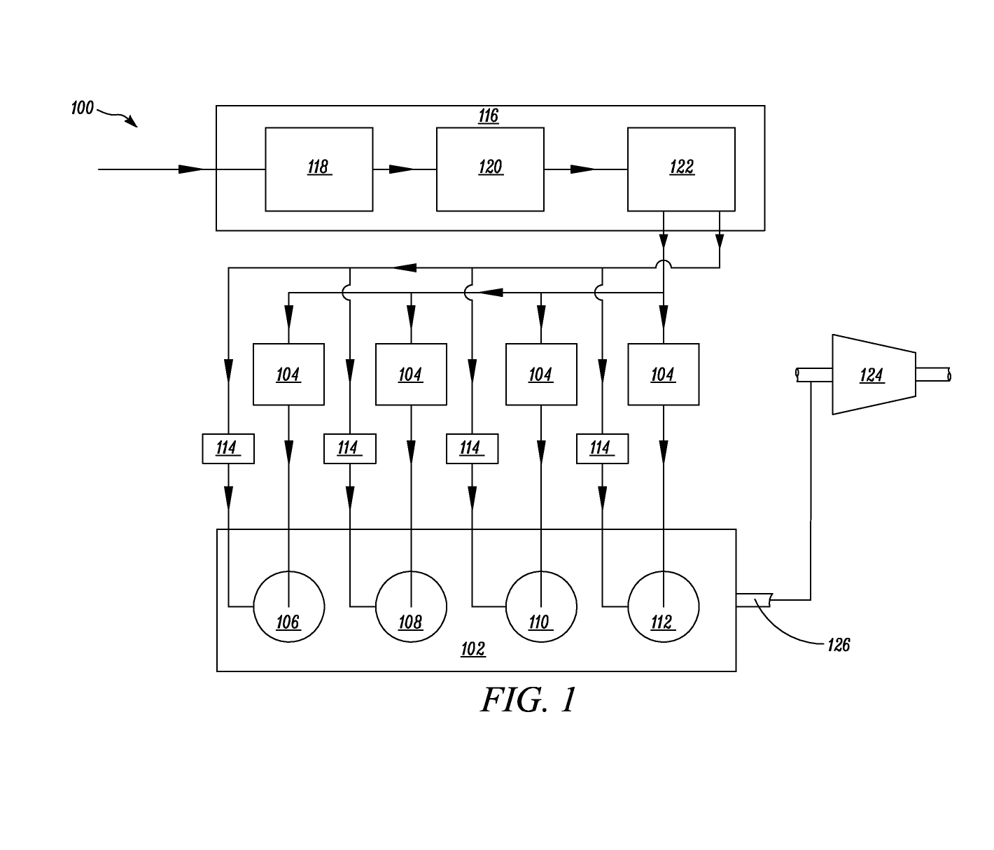

The present disclosure relates to a control system for fuel delivery systems associated with cylinders of a multi-cylinder engine. FIG. 1 shows a schematic of a power system 100 in which disclosed embodiments may be implemented. The power system 100 includes a multi-cylinder engine 102. In one embodiment, the multi-cylinder engine 102 may be used to drive power generating assemblies such as generators. In other embodiments, the multi-cylinder engine 102 may be used to drive other mechanical assemblies such as compressors. In one embodiment, the multi-cylinder engine 102 may be a reciprocating engine. In an embodiment, the multi-cylinder engine 102 may be a two stroke internal combustion engine. In another embodiment, the multi-cylinder engine 102 may be a four stroke internal combustion engine.

In an embodiment, the multi-cylinder engine 102 may be configured to operate on varying thermodynamic cycles. In one embodiment, the multi-cylinder engine 102 may be configured to operate on a diesel combustion cycle. Accordingly, the multi-cylinder engine 102 may use any compression ignited fuel that is compatible with the diesel combustion cycle, for example, diesel. In another embodiment, the multi-cylinder engine 102 may be configured to operate on an Otto cycle. Therefore, in this embodiment, the multi-cylinder engine 102 may use any spark ignited fuel compatible with the Otto cycle, for example, gasoline, natural gas, synthesis gas (syngas).

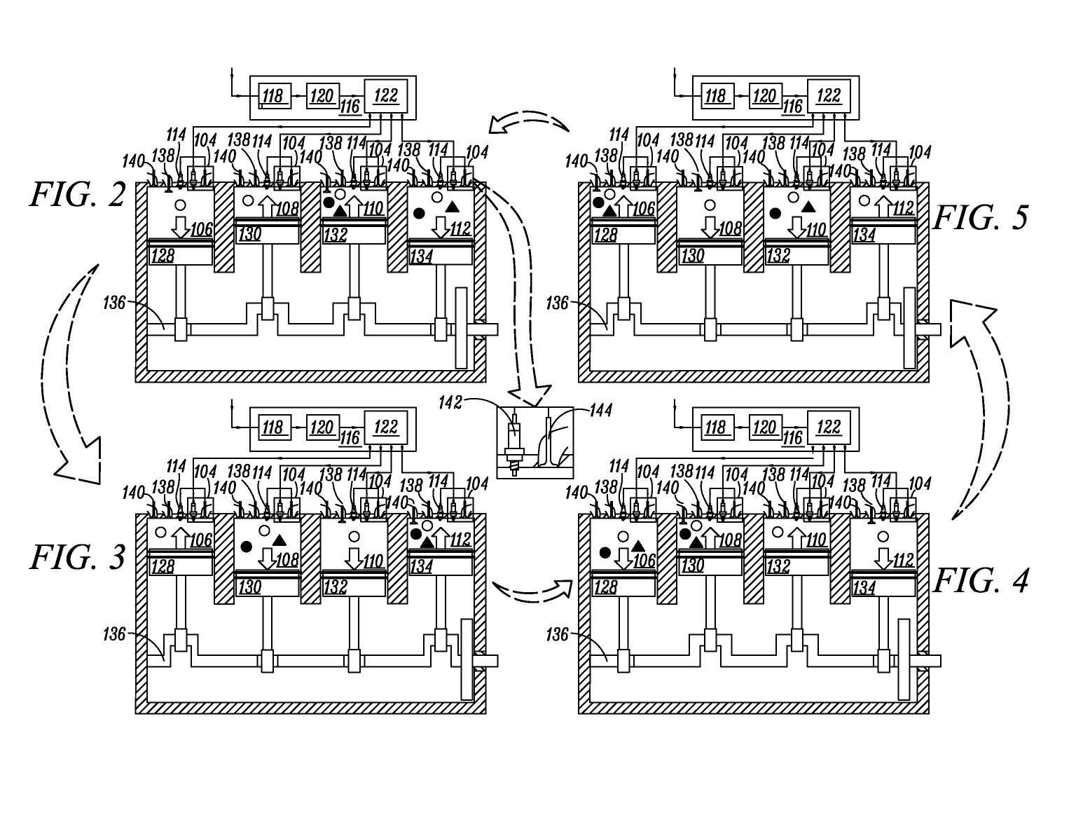

The power system 100 further includes multiple fuel delivery systems 104 associated with cylinders 106, 108, 110, and 112 of the multi-cylinder engine 102. The fuel delivery system 104 is configured to selectively deliver at least one of the compression ignited fuel and the spark ignited fuel. In an embodiment the power system 100 may further include one or more ignition sources 114 associated with each of the cylinders 106, 108, 110, and 112. The ignition sources 114 may be configured to ignite the spark ignited fuel. In an embodiment as shown in FIGS. 2-17, the ignition sources 114 may be spark plugs. However, a person having ordinary skill in the art may acknowledge that other ignition sources 114 commonly known in the art may be used to ignite the spark ignited fuel.

As shown in FIG. 1, the power system 100 further includes a control system 116 operatively connected to the fuel delivery systems 104. The control system 116 includes a detector 118, a processor 120, and a controller 122. The detector 118 is configured to sense a signal to change from the compression ignited fuel to the spark ignited fuel in a pre-determined number of cylinders out of the four cylinders 106, 108, 110, and 112. In an embodiment, the detector 118 may be configured to sense a signal to change a fuel type from diesel to natural gas. In an embodiment, the signal may be triggered by an operator input from a manual selector switch (not shown). In another embodiment, the signal may be a feedback signal from an auxiliary detector (not shown) based on an instantaneous change in operating conditions of the multi-cylinder engine 102 or the power system 100.

The processor 120 is configured to receive the signal from the detector 118 and generate one or more actuation signals. The controller 122 is configured to receive the actuation signals and tandemly control the fuel delivery systems 104 associated with the pre-determined cylinders out of the four cylinders 106, 108, 110, and 112 based on the actuation signals. In an embodiment, the pre-determined cylinders out of the four cylinders 106, 108, 110, and 112 may be selected based on an operating parameter of the multi-cylinder engine 102. In an embodiment as shown in FIG. 1, the operating parameter may be a load on the multi-cylinder engine 102. In one embodiment as shown in FIG. 1, the load on the multi-cylinder engine 102 may be a turbocharger 124 that is driven by thermal energy and/or kinetic energy from an exhaust 126 of the multi-cylinder engine 102. In another embodiment the load may be a physical load driven by the multi-cylinder engine 102. In another embodiment, the operating parameter may be a speed of the multi-cylinder engine 102.

According to an aspect of the present disclosure, a change in the fuel type from the compression ignited fuel to the spark ignited fuel in the multi-cylinder engine 102 will be explained in the appended description pertaining to FIGS. 2-17. For the purposes of understanding the various embodiments of the present disclosure, explanation will be made with regards to a four-stroke, four cylinder in-line internal combustion engine as illustrated in FIGS. 2-17. Further, a symbolic representation made to reactants and products in FIGS. 2-17 is shown in the table below.

| Reactants/Products | Symbol |
|---|---|
| Compressed ignited fuel (e.g. | |
| Diesel) | |
| Air | ∘ |
| Spark ignited fuel (e.g. Gasoline/ | ▪ |
| Natural gas) | |
| By-products | ▴ |

In an embodiment as shown in FIGS. 2-17, the multi-cylinder engine 102 may include pistons 128, 130, 132, and 134 disposed within the cylinders 106, 108, 110, and 112 respectively. Each of the pistons 128, 130, 132, and 134 may be interconnected by a common crank shaft 136. Further, the pistons 128, 130, 132, and 134 may be configured to reciprocate within the respective cylinders 106, 108, 110, and 112 and collectively rotate the crank shaft 136. For the purposes of clarity in understanding the present disclosure, vertical arrows, upwards or downwards, illustrated in FIGS. 2-17 may indicate a direction of travel of the pistons 128, 130, 132, and 134, in the cylinders 106, 108, 110, and 112 for the respective strokes.

The multi-cylinder engine 102 may further include air inlet valves 138, and exhaust valves 140 associated with each of the cylinders 106, 108, 110, and 112. The air inlet valves 138 may be configured to supply air into the cylinders 106, 108, 110, and 112 while the exhaust valves 140 may be configured to allow by-products resulting due to combustion of fuel to escape into atmosphere.

In an embodiment as shown in FIGS. 2-17, the fuel delivery systems 104 may include injectors 142 and fuel valves 144. The injectors 142 and the fuel valves 144 may be configured to deliver compression ignited fuel and spark ignited fuel respectively into the cylinders 106, 108, 110, and 112. In an embodiment, the injectors 142 may be configured to deliver diesel while the fuel valves 144 may be configured to deliver natural gas. In other embodiments, the injectors 142 and the fuel valves 144 may be configured to deliver other compression ignited fuels and spark ignited fuels commonly known in the art.

A firing order commonly known in the art may be selected for the cylinders 106, 108, 110, and 112 of the four-cylinder engine 102. Some of the commonly known firing orders are listed below.

Common firing orders

1-3-4-2
1-2-4-3
1-3-2-4
1-4-3-2
1-2-3-4

For the purposes of understanding the various embodiments of the present disclosure, explanation for FIGS. 2-17 will be made with regards to the multi-cylinder engine 102 with a firing order of 1-3-4-2. However, it is to be noted that any firing order may be used based on an application and its subsequent requirements. Therefore, the firing order disclosed in embodiments herein is merely exemplary in nature and hence, non-limiting to this disclosure.

FIGS. 2-5 illustrate the power system 100 with the multi-cylinder engine 102 operating on the compression ignited fuel. In an embodiment as shown in FIG. 2, pistons 128, 130, 132, and 134 may undergo an intake stroke, a compression stroke, an exhaust stroke and a power stroke respectively. Referring to FIG. 3, pistons 128, 130, 132, and 134 may undergo a compression stroke, a power stroke, an intake stroke, and an exhaust stroke. Referring to FIG. 4, pistons 128, 130, 132, and 134 may undergo a power stroke, an exhaust stroke, a compression stroke, and an intake stroke. Referring to FIG. 5, pistons 128, 130, 132, and 134 may undergo an exhaust stroke, an intake stroke, a power stroke, and a compression stroke. Referencing FIGS. 4, 5, 2 and 3 in the aforesaid sequence, it may be evident to a person having ordinary skill in the art that the pistons 128, 132, 134, and 130 execute the respective power strokes in the exemplary firing order 1-3-4-2.

For the purpose of the present disclosure, in an exemplary transitioning regime based on the operating parameter of the multi-cylinder engine 102, the pre-determined cylinders may be cylinders 106 and 110 out of the four cylinders 106, 108, 110, and 112 shown in FIGS. 2-5. Although it is disclosed herein that the two pre-determined cylinders are selected as the cylinders 106 and 108, it is to be noted that the pre-determination of number of cylinders and the selection of the cylinders are exemplary in nature. Therefore, any number of cylinders may be pre-determined and any specific cylinder/s 106, 108, 110, and 112 may be selected to constitute the pre-determined cylinders based on the operating parameter of the multi-cylinder engine 102.

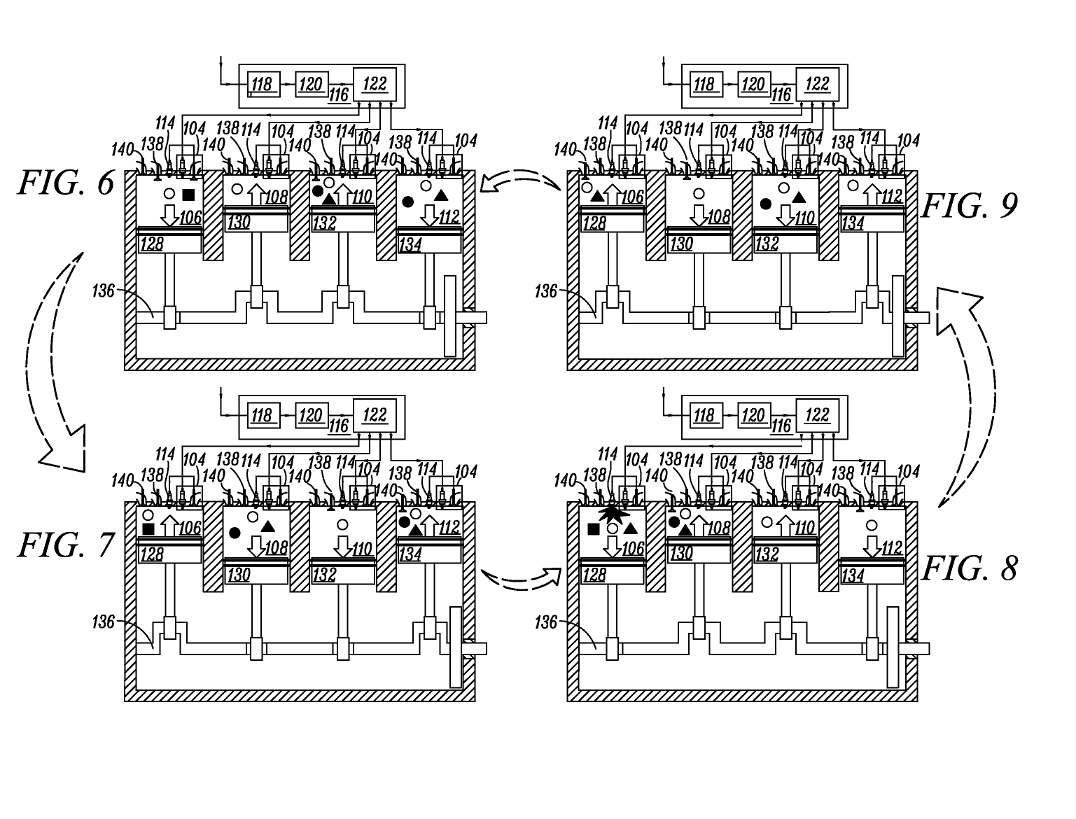

Referring to FIG. 6, the pistons 130, 132, and 134 may undergo a compression stroke, an exhaust stroke, and a power stroke respectively. In an embodiment, the controller 122 may be configured to tandemly shut off a delivery of the compression ignited fuel from the fuel delivery systems 104 associated with the pre-determined cylinders 106 and 110. In a further embodiment, the controller 122 may be configured to selectively switch on a delivery of the spark ignited fuel from the fuel delivery systems 104 associated with the pre-determined cylinders 106 and 110. Therefore, in an embodiment as shown in FIG. 6, the controller 122 may be configured to shut off the delivery of the compression ignited fuel and switch on the delivery of the spark ignited fuel from the fuel delivery system 104 associated with the pre-determined and selected cylinder 106.

Referring to FIG. 7, the pistons 130, 132, and 134 may operate on the compression ignited fuel and undergo a power stroke, an intake stroke, and an exhaust stroke while the piston 128 may operate on the spark ignited fuel and undergo a compression stroke. Referring to FIG. 8, the pistons 130, 132, and 134 may operate on the compression ignited fuel and undergo an exhaust stroke, a compression stroke, and an intake stroke respectively while the piston 128 may operate on the spark ignited fuel and undergo a power stroke. In an embodiment, the controller 122 may be configured to switch on the ignition source 114 associated with the pre-determined and selected cylinder 106.

Referring to FIG. 9, the pistons 130, 132, and 134 may operate on the compression ignited fuel and undergo an intake stroke, a power stroke, and a compression stroke respectively while the piston 128 may operate on the spark ignited fuel and undergo an exhaust stroke.

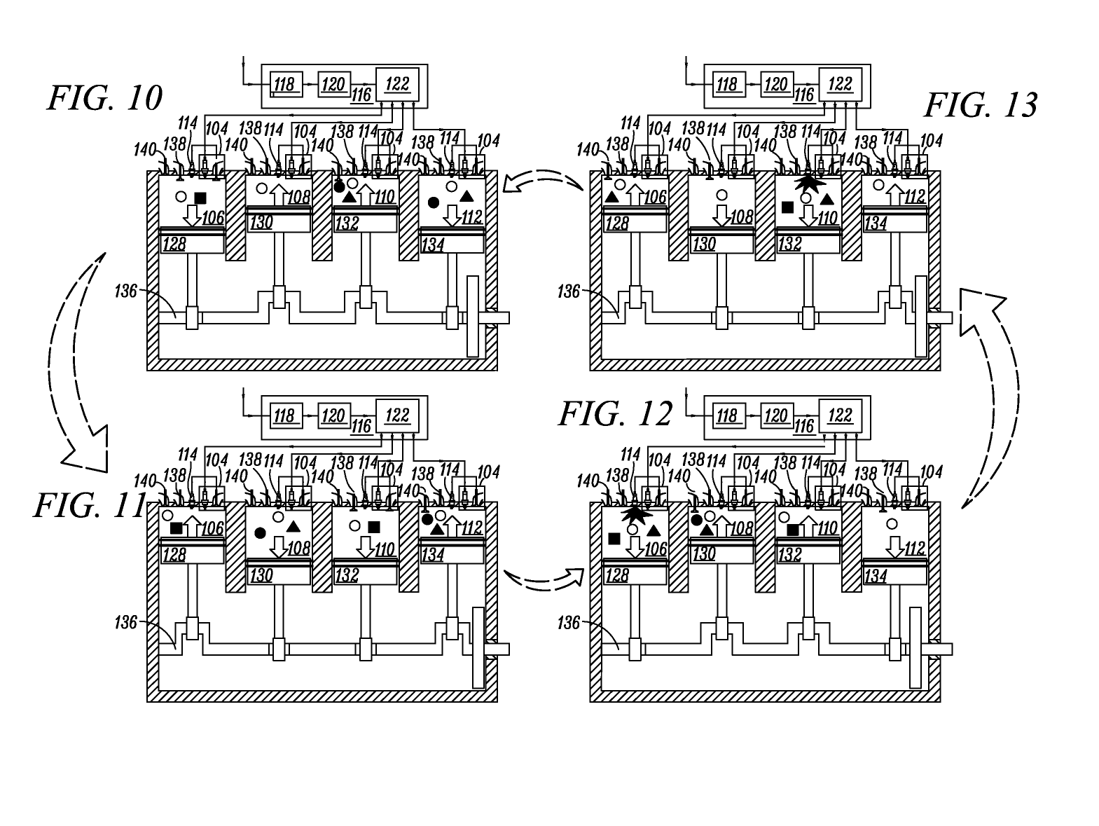

Referring to FIG. 10, the pistons 130, 132, and 134 may operate on the compression ignited fuel and undergo a compression stroke, an exhaust stroke, and a power stroke respectively while the piston 128 may operate on the spark ignited fuel and undergo an intake stroke.

Referring to FIG. 11, the pistons 130 and 134 may operate on the compression ignited fuel and undergo a power stroke and an exhaust stroke respectively while the piston 128 may operate on the spark ignited fuel and undergo a compression stroke. In an embodiment as shown in FIG. 11, the controller 122 may be configured to shut off the delivery of the compression ignited fuel and switch on the delivery of the spark ignited fuel from the fuel delivery system 104 associated with the pre-determined and selected cylinder 110.

In this manner, the controller 122 may be configured to tandemly control the fuel delivery systems 104 associated with the pre-determined cylinders 106 and 110 based on the actuation signals received by the controller 122. The tandem control of the fuel delivery systems 104, disclosed herein, may represent shutting off compression ignited fuel and initiating delivery of spark ignited fuel to the pre-determined cylinders 106 and 110 in a cylinder by cylinder or step-wise manner. FIGS. 12-13 illustrate subsequent cycles of operation of the multi-cylinder engine 102 running on spark ignited fuel in cylinders 106 and 110 and compression ignited fuel in cylinders 108 and 112.

With reference to FIGS. 2-5, a person having ordinary skill in the art may acknowledge that during power strokes executed by pistons 130, 128, 132, and 134 in FIGS. 3, 4, 5 and 2 respectively, by-products may be produced in addition to heat and energy. The by-products may include one or more of unburned diesel, partially cracked hydro-carbon molecules, nitrous-oxides (NOx), free radicals such as hydroxyl (OH⁻) or hydrogen (H⁺), particulate matter (a matrix of carbon and volatile organic compounds), sulfuric acid, and nitric acid. Further, a temperature of these by-products may be hot. Although the pistons 130, 128, 132, and 134 may travel upwards in FIGS. 4, 5, 2 and 3 to forcibly exhaust the by-products, some of the by-products may typically be left behind in the cylinders 108, 106, 110, and 112. As known to one having ordinary skill in the art, the aforesaid by-products and their temperatures may hamper a transitioning of fuel type from the compression ignited fuel to the spark ignited fuel.

In an embodiment, the controller 122 may be configured to shut off a delivery of the compression ignited fuel from the fuel delivery systems 104 associated with the pre-determined cylinders 106 and 110. In a further embodiment, the controller 122 may be configured to switch off a delivery of the spark ignited fuel from the fuel delivery systems 104 associated with the pre-determined cylinders 106 and 110. Therefore, the controller 122 may be configured to shut off a delivery of the compression ignited fuel and the spark ignited fuel to the pre-determined cylinders 106 and 110 such that the pre-determined cylinders 106 and 110 may execute one or more motoring cycles. Motoring cycles disclosed herein, may represent an idle reciprocation of a piston within a cylinder in the absence of fuel. The motoring cycle may include an intake stroke, one or more dry strokes based on an engine type, and an exhaust stroke. These strokes of the motoring cycles may occur in the absence of fuel thus helping to flush out any residual by-products left behind in the pre-determined cylinders 106 and 110 due to the ignition of the compression ignited fuel.

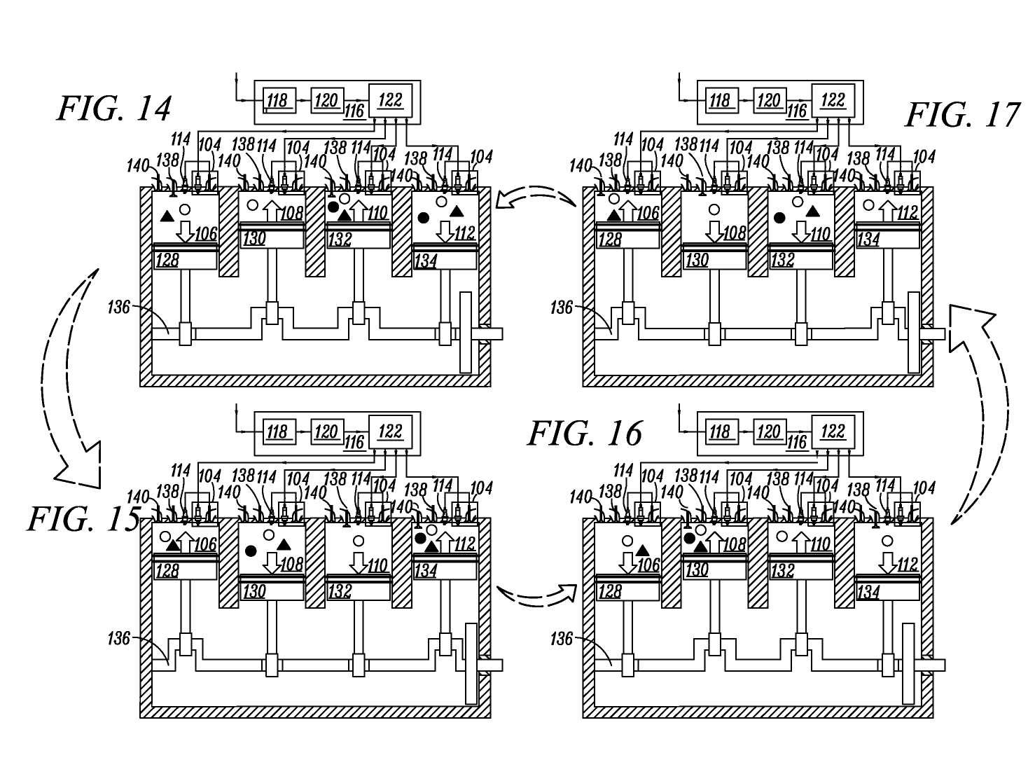

As shown in FIGS. 14-17, the controller 122 may be configured to shut off a delivery of the compression ignited fuel and the spark ignited fuel to the pre-determined cylinder 106 such that a motoring cycle begins in piston 128 of FIG. 14 and continues through FIGS. 15-17. However, it is to be noted that the piston 128 of FIG. 14 may be configured to receive air, and may execute two dry strokes as shown in FIGS. 15-16 respectively. Further, as shown in FIG. 17 the piston 128 may travel upwards to forcibly exhaust the by-products along with air.

It is to be noted that the motoring cycles of FIGS. 14-17 disclosed herein may occur after the cycles of operation shown in FIGS. 2-5 wherein the multi-cylinder engine 102 may run on compression ignited fuel in all its cylinders 106, 108, 110, and 112. However, the motoring cycles of FIGS. 14-17 occur prior to the cycles of operation shown in FIGS. 6-13 wherein the multi-cylinder engine 102 may be running on spark ignited fuel in the pre-determined cylinders 106, 110 and compression ignited fuel in the remaining cylinders 108, 112. Therefore, the introduction of one or more motoring cycles in the pre-determined cylinders 106, 110 may be based on an anticipation of transitioning from the compression ignited fuel to the spark ignited fuel. These motoring cycles may help to flush out any residual by-products left behind in the pre-determined cylinders 106, 110 prior to introducing the spark ignited fuel in the pre-determined cylinders 106, 110.

### INDUSTRIAL APPLICABILITY

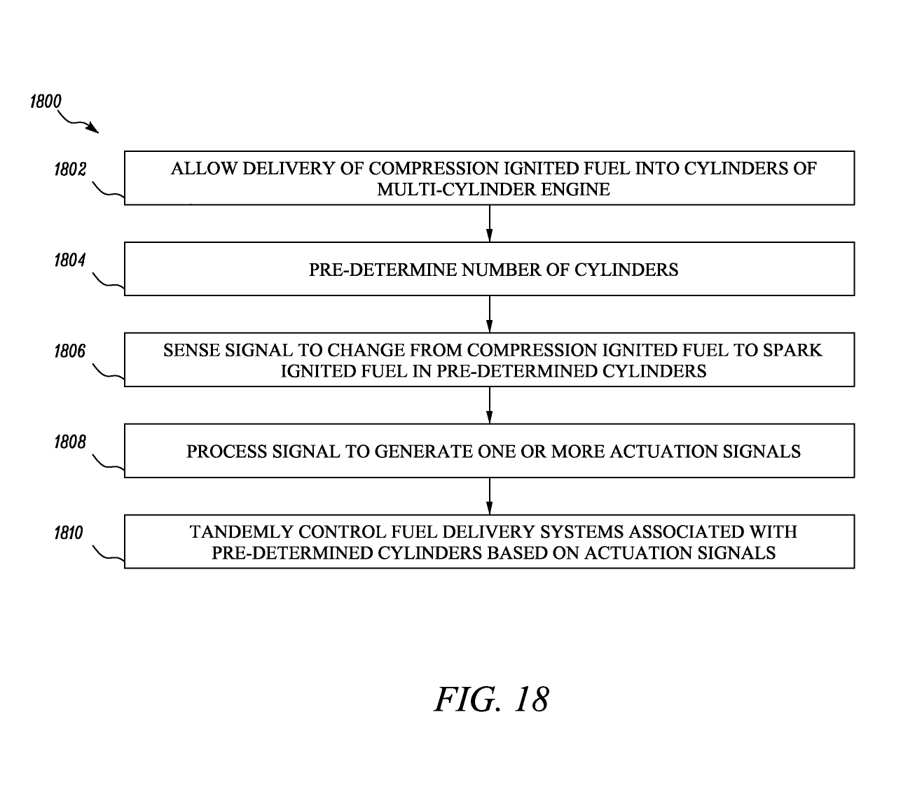

FIG. 18 shows a method of changing a fuel type in the multi-cylinder engine 102. At step 1802, the method includes allowing delivery of a compression ignited fuel into cylinders 106, 108, 110, and 112 of the multi-cylinder engine 102. At step 1804, the method further includes pre-determining a number of cylinders. At step 1806, the method further includes sensing a signal to change from the compression ignited fuel to a spark ignited fuel in the pre-determined cylinders 106, 110. At step 1808, the method further includes processing the signal to generate one or more actuation signals. At step 1810, the method further includes tandemly controlling the fuel delivery systems 104 associated with the pre-determined cylinders 106 and 110 based on the actuation signals.

In an embodiment, pre-determining the number of cylinders may be based on an operating parameter of the multi-cylinder engine 102. In a further embodiment, the operating parameter may be the load on the multi-cylinder engine 102. In another embodiment, the operating parameter may be the speed of the multi-cylinder engine 102.

In one embodiment, tandemly controlling the fuel delivery systems 104 may include tandemly shutting off a delivery of the compression ignited fuel from the fuel delivery systems 104 associated with the pre-determined cylinders 106 and 110. In a further embodiment, tandemly controlling the fuel delivery system 104 may include selectively switching on the delivery of the spark ignited fuel from the fuel delivery systems 104 associated with the pre-determined cylinders 106 and 110. In a further embodiment, the method may further include switching on one or more ignition sources 114 associated with the pre-determined cylinders 106 and 110.

When transitioning from the compression ignited fuel to the spark ignited fuel in a typical dual-fuel engine, residual by-products resulting from the combustion of the compression ignited fuel may be left behind in the cylinders of the engine. Pre-ignition characteristics of spark ignited fuels may be different from that of compression ignited fuels. The residual by-products left behind in the cylinders of the engine may cause detrimental effects such as knocking, or detonation from pre-ignition of the spark ignited fuel.

Further, conventional fuel changeover systems known in the art may allow a change in fuel type input to the engine. However, the conventional fuel changeover systems may change the fuel type in all of the cylinders of the engine at once. Therefore, the sudden change in fuel type may increase the knocking effect across all cylinders thereby reducing engine performance and power output instantaneously. Therefore, a decreased power output of the engine may be inadequate to drive loads such as a turbocharger which may require a substantial amount of thermal energy and kinetic energy from the exhaust gases.

The knocking effect may be reduced by gradually stepping up each cylinder 106, 108, 110, and 112 of the engine on the spark ignited fuel as compared to introducing the spark ignited fuel into all the cylinders 106, 108, 110, and 112 at once. In the power system 100 as shown in FIGS. 6-13, the controller 122 may be configured to tandemly control the fuel delivery systems 104 associated with the pre-determined cylinders 106 and 110. Therefore, the controller 122 may tandemly step up each cylinder 106, 108, 110, 112 or groups of cylinders 106 and 110 such that a gradual transition of fuel type occurs across the multi-cylinder engine 102 without significant reduction in power output.

In an embodiment, the knocking effect may be further reduced by flushing out the residual by-products prior to delivering the spark ignited fuel. In an embodiment as shown in FIGS. 14-17, the controller 122 may be configured to selectively shut off the delivery of the spark ignited fuel from the fuel delivery systems 104 associated with the pre-determined cylinders 106 and 110. Therefore, motoring cycles may be tandemly introduced in the pre-determined cylinders 106 and 110 prior to switching on the delivery of spark ignited fuel to the pre-determined cylinders 106 and 110.

A person having ordinary skill in the art may acknowledge that sudden introduction of motoring cycles across most or all cylinders at once may lead to significant power drop in an engine and also stalling of the engine in some cases. However, with regards to the power system 100 disclosed herein, it may be noted that in one embodiment, the pre-determination of the number of cylinders may be done such that the load on the multi-cylinder engine 102 is driven by the remaining cylinders 108 and 112 operating on compression ignited fuel while the pre-determined cylinders 106 and 110 execute motoring cycles respectively.

In another embodiment, the pre-determination of the number of cylinders may be done such that the load on the multi-cylinder engine 102 is driven together by the pre-determined cylinders 106 and 110 and the remaining cylinders 108 and 112 operating on spark ignited fuel and compression ignited fuel respectively. Therefore, the controller 122 disclosed herein may effect a smooth transition from a compression ignited fuel to a spark ignited fuel in the multi-cylinder engine 102. Further, an occurrence of knocking in the multi-cylinder engine 102 may be avoided thereby reducing a likelihood of sudden power drops. Therefore, an implementation of the control system 116 disclosed herein in multi-cylinder engines 102 may improve engine performance and prolong engine life.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

We claim:

1. A control system for fuel delivery systems associated with cylinders of a multi-cylinder engine, the control system including:
a detector configured to sense a signal to change from a compression ignited fuel to a spark ignited fuel in a pre-determined number of cylinders;
a processor configured to receive the signal from the detector and generate one or more actuation signals; and
a controller configured to receive the actuation signals and tandemly control the fuel delivery systems associated with the pre-determined cylinders based on the actuation signals.

2. The control system of claim 1, wherein the pre-determined cylinders is selected based on an operating parameter of the multi-cylinder engine.

3. The control system of claim 2, wherein the operating parameter is one of load and speed of the multi-cylinder engine.

4. The control system of claim 1, wherein the controller is configured to tandemly shut off a delivery of the compression ignited fuel from the fuel delivery systems associated with the pre-determined cylinders.

5. The control system of claim 4, wherein the controller is configured to selectively switch on a delivery of the spark ignited fuel from the fuel delivery systems associated with the pre-determined cylinders.

6. The control system of claim 5, wherein the controller is configured to switch on one or more ignition sources associated with the pre-determined cylinders.

7. A power system including:
a multi-cylinder engine;
a plurality of fuel delivery systems associated with cylinders of the multi-cylinder engine and configured to deliver at least one of a compression ignited fuel and a spark ignited fuel; and
a control system operatively connected to the fuel delivery systems, the control system including:
a detector configured to sense a signal to change from the compression ignited fuel to the spark ignited fuel in a pre-determined number of cylinders;
a processor configured to receive the signal from the detector and generate one or more actuation signals; and
a controller configured to receive the actuation signals and tandemly control the fuel delivery systems associated with the pre-determined cylinders based on the actuation signals.

8. The power system of claim 7, wherein the pre-determined cylinders is selected based on an operating parameter of the engine.

9. The power system of claim 8, wherein the operating parameter is one of load and speed of the engine.

10. The power system of claim 7, wherein the controller is configured to tandemly shut off a delivery of the compression ignited fuel from the fuel delivery systems associated with the pre-determined cylinders.

11. The power system of claim 10, wherein the controller is configured to selectively switch on a delivery of the spark ignited fuel from the fuel delivery systems associated with the pre-determined cylinders.

12. The power system of claim 11, wherein the controller is configured to switch on one or more ignition sources associated with the pre-determined cylinders.

13. A method of changing a fuel type in a multi-cylinder engine, the method including:
allowing delivery of a compression ignited fuel into cylinders of the multi-cylinder engine;
pre-determining a number of cylinders;
sensing a signal to change from the compression ignited fuel to a spark ignited fuel in the pre-determined cylinders;
processing the signal to generate one or more actuation signals; and
tandemly controlling the fuel delivery systems associated with the pre-determined cylinders based on the actuation signals.

14. The method of claim 13, wherein pre-determining the number of cylinders is based on an operating parameter of the multi-cylinder engine.

15. The method of claim 14, wherein the operating parameter is one of load and speed of the multi-cylinder engine.

16. The method of claim 13, wherein tandemly controlling the fuel delivery systems includes tandemly shutting off a delivery of the compression ignited fuel from the fuel delivery systems associated with the pre-determined cylinders.

17. The method of claim 16, wherein tandemly controlling the fuel delivery system includes selectively switching on a delivery of the spark ignited fuel from the fuel delivery systems associated with the pre-determined cylinders.

18. The method of claim 17 further including switching on one or more ignition sources associated with the pre-determined cylinders.
